(19) United States
(12) Patent Application Publication
(10) Pub. No.: US 2018/0340747 A1
(43) Pub. Date: Nov. 29, 2018

(54) PRECOATED FIN AND HEAT EXCHANGER

(71) Applicant: UACJ Corporation, Tokyo (JP)

(72) Inventors: Mikine SASAZAKI, Aichi (JP); Kaoru UEDA, Aichi (JP)

(21) Appl. No.: 15/776,128

(22) PCT Filed: Nov. 16, 2016
(86) PCT No.: PCT/JP2016/083953

§ 371 Date: May 15, 2018

(30) Foreign Application Priority Data
Nov. 20, 2015 (JP) 2015-228230

(51) Int. Cl. F28F 19/04; F28F 1/32; C09D 101/02; C09D 163/10; C09D 171/02

(52) U.S. Cl. CPC F28F 19/04; F28F 1/32; C09D 101/02; B32B 15/20; C09D 171/02; F28F 2245/02; C09D 163/10

(57) ABSTRACT

A heat exchanger includes a plurality of fins composed a precoated aluminum sheet (1) having a substrate (2) composed of aluminum, and a hydrophilic-coating film (3) formed on at least one surface thereof. The precoated aluminum sheets (1) have a surface roughness Rz_{L} of the hydrophilic-coating film (3) in a rolling-parallel direction X of the substrate (2) and a surface roughness Rz_{LT} of the hydrophilic-coating film (3) in a rolling-perpendicular direction of the substrate (2). These surface roughnesses satisfy the following relationships: Rz_{L}≤1.5 μm, 0.3 μm≤Rz_{LT}≤2.5 μm, and Rz_{L}/Rz_{LT}≤0.9. A contact angle α of a water droplet (19) with respect to the hydrophilic-coating film (3) is 25° or less, and a sliding angle β of the water droplet (19) in the rolling-parallel direction X is 20° or less.

### CROSS-REFERENCE

This application is the US national stage of International Patent Application No. PCT/JP2016/083953 filed on Nov. 16, 2016, which claims priority to Japanese Patent Application 2015-228230 filed on Nov. 20, 2015.

### TECHNICAL FIELD

The present invention relates to precoated fins, each having a substrate composed of aluminum or an aluminum alloy, and a hydrophilic-coating film, which is formed on a surface thereof, and to a heat exchanger comprising such precoated fins.

### BACKGROUND ART

Fin-tube heat exchangers are often used, e.g., in air conditioners. Such heat exchangers typically comprise tubing made of copper or aluminum, and numerous plate fins made of aluminum. The tubing passes through the plate fins. The plate fins are formed by casting aluminum or an aluminum alloy, and then hot rolling and cold rolling into a coil shape; a hydrophilic paint or a water-repellent paint is then precoated on both sides.

In recent years, there has been demand for improvement in the heat-exchanging performance of heat exchangers and improvement in the hydrophilicity of the fins with the aim of reducing noise during operation. There is also demand for contamination resistance and water-scattering resistance in the fins of indoor units in order to prevent water scatter and dew scatter and to prolong the hydrophilic performance. In addition, to conserve energy, there is continuing demand for improved defrosting properties in the fins of outdoor units, and the idea of increasing the number of fins by narrowing the fin pitch is being studied.

Air conditioners for home use and for business use comprise indoor units and outdoor units, which are connected by tubing, through which a coolant circulates. In the interiors of the indoor unit and the outdoor unit, there are heat exchangers having fins provided on a coolant-passageway tube; fans for delivering an air draft to the heat exchanger and motors for driving the fans are also respectively disposed in the interiors of the indoor unit and the outdoor unit. A compressor and an expansion valve are incorporated within a passage (conduit) that connects the indoor unit and the outdoor unit, and heat exchange is performed. During a cooling operation, the heat of the coolant, which became high temperature owing to being compressed by the compressor, is dissipated to the outdoor space by the outdoor unit. This cooled-down coolant is then evaporated by being passed through the expansion valve and the evaporated coolant, whose temperature has become low, passes through the indoor unit, so that a cold air draft is supplied to the indoor space. The cooling operation cycle is completed by compressing the coolant, which has absorbed heat from the indoor space, once again by the compressor.

In contrast, during a heating operation, the heat of the coolant, which became high temperature owing to being compressed by the compressor, is discharged to the indoor space by the indoor unit. This cooled-down coolant is then evaporated by being passed through the expansion valve and the evaporated coolant, whose temperature has become low, passes through the outdoor unit and absorbs heat from the outdoor space. The heating operation cycle is completed by compressing the coolant that has absorbed heat from the outdoor space once again by the compressor. Normally, when a heating operation is being performed and the outdoor temperature is low, it is necessary to ensure that the outdoor temperature of the coolant (i.e. the temperature of the coolant while it is in the outdoor unit) is lower than the outdoor temperature so that the coolant can absorb heat from the outdoor space. Consequently, the coolant temperature sometimes becomes 0° C. or lower. However, if the temperature of the coolant becomes 0° C. or lower, then the temperature of the fins that contact the tubing inevitably becomes 0° C. or lower, and therefore moisture in the air adheres to the fins and frost may form on the fins.

If frost adheres to the fins of the outdoor unit, the frost becomes a barrier (a quasi-insulator) between the coolant and the outdoor air, thereby impeding movement (transfer) of heat. In addition, the frost occupies space between the fins, thereby decreasing the amount of air that can flow between the fins decreases, whereby a much greater decrease in heat-exchanging performance results. If an excessively large amount of frost adheres and the heat-exchanging performance decreases, then it becomes necessary to temporarily stop the heating operation and perform a defrosting operation to remove that frost. In the defrosting operation, the coolant that passes through the outdoor unit is heated up to a temperature that will melt the frost on the fins, such that the frost is changed to water by the circulation of the coolant for a fixed time, and the water is subsequently discharged. However, a defrost operation is problematic in that energy is needed to heat the coolant and in that indoor comfort is impaired because the heating operation is temporarily stopped. Consequently, various techniques for reducing the adherence of frost have been proposed.

For example, in the below-identified Patent Document 1, a hydrophilic-coating film containing a hydrophilic resin and cross-linkable fine particles is proposed. Furthermore, as the hydrophilic resin, a hydrophilic-coating film is proposed, in which a metal surface is covered with a hydrophilic film using a hydrophilization treatment agent containing a specified (meth)acrylic resin, polyvinyl alcohol and at least one resin selected from polyethylene oxide and polyethylene glycol.

In the below-identified Patent Document 2, a water-sheeting coating agent is proposed that contains an organosilicon compound component, which is composed of a mixture of a partial hydrolysate of polyorganosiloxane and a partial hydrolysate of fluoroalkylsilane, and an organic solvent capable of dissolving the organosilicon compound component.

In the below-identified Patent Document 3, a water-repellent coating composition composed of an organic-resin solution and fine particles is proposed.

In the below-identified Patent Document 4, a frost-formation-prevention treatment composition is proposed in which a cross-linking agent, a fluorine-based polymer, and an antifoaming agent are admixed into a specified acrylic-modified epoxy resin.

### PRIOR ART LITERATURE

### Patent Documents

Patent Document 1: Japanese Laid-open Patent Publication 2014-000534

Patent Document 2: Japanese Laid-open Patent Publication 2013-147573

Patent Document 3: Japanese Laid-open Patent Publication H5-117637

Patent Document 4: Japanese Laid-open Patent Publication 2011-102334

### SUMMARY OF THE INVENTION

With respect to the hydrophilic-coating film of Patent Document 1, because condensed water wets and spreads on the fin surfaces, it is characterized in that the ventilation resistance can be maintained low and heat-exchanging performance is high. However, owing to the effects of that high hydrophilicity, a thin water film tends to be maintained on the fin surfaces. Furthermore, because the hydrophilic-coating film surfaces have a rough unevenness, hydrophilicity is caused to be exhibited, and consequently the water film tends not to flow off. As a result, the hydrophilic-coating film of Patent Document 1 is problematic because frost tends to adhere to the fins of the outdoor unit during a heating operation.

In addition, the water-sheeting coating agent of Patent Document 2 enables a coating film to be formed that excels in water sheeting and can be maintained for a long time. However, the water-sheeting coating agent is suited for postcoating; it is not suited for precoating. In addition, the water-sheeting durability of the coating film formed by the water-sheeting coating agent is insufficient.

Patent Document 3 proposes to lengthen the frost-formation time by making the fin surfaces ultra-water-repellent using a coating having the water-repellent coating composition described above. However, the contact-surface area between the fin surfaces, which have a high coefficient of heat transfer, and the condensed water becomes small. As a result, the surface area over which the fin surfaces contact the air, which has a low coefficient of heat transfer, becomes large, and consequently heat-exchanging performance becomes low. In addition, condensed water tends to turn into ice rather than frost. Consequently, during a defrosting operation (thawing operation), instead of frost melting, the ice tends to drop off, and there is a risk that an ice mass will build up inside the outdoor unit. As a result, a separate apparatus for removing the ice mass that has accumulated inside the outdoor unit becomes necessary.

In Patent Document 4, the frost-formation-prevention treating composition suppresses the formation of frost in the outdoor unit, and thereby a coating that excels in corrosion resistance can be formed. However, water-sheeting is insufficient and therefore there is a demand for further improvement.

In view of one or more of these circumstances, one aspect of the present teachings concerns a precoated aluminum sheet for a fin of a heat exchanger that excels in sheeting of condensed water while also exceling in hydrophilicity over a long time, can sufficiently prevent or inhibit the adherence of frost, and excels in frost removal properties. Heat exchangers are also disclosed.

In another aspect of the present teachings, a precoated aluminum plate for a fin of a heat exchanger preferably comprises:

a substrate composed of aluminum; and

a hydrophilic-coating film formed on at least one surface of the substrate; wherein:

a surface roughness Rz_{L} of the hydrophilic-coating film in a rolling-parallel direction of the substrate and a surface roughness Rz_{LT} of the hydrophilic-coating film in a rolling-perpendicular direction of the substrate satisfy the relationships Rz_{L}≤1.5 μm, 0.3 μm≤RZ_{LT}≤2.5 μm, and Rz_{L}/Rz_{LT}≤0.9; and

a contact angle of a water droplet with respect to the hydrophilic-coating film is 25° or less, and a sliding angle of a water droplet in the rolling-parallel direction of the substrate is 20° or less.

In another aspect of the present teachings, a heat exchanger comprises a fin composed of such a precoated aluminum sheet.

The above-described precoated aluminum sheet includes the hydrophilic-coating film in which the surface roughness Rz_{L} and the surface roughness Rz_{LT} satisfy the above-mentioned relationships. Furthermore, the contact angle of the water droplet with respect to the hydrophilic-coating film and the water droplet sliding angle are the above-mentioned prescribed values (angles) or less. Consequently, the precoated aluminum sheet excels in hydrophilicity and, even if cohered (condensed) water adheres to a surface, the cohered water tends to slide off. Furthermore, when sliding off, it is possible to prevent wetting and spreading of the cohered water on the surface of the hydrophilic-coating film. Furthermore, the precoated aluminum sheet can maintain such excellent hydrophilicity and sliding-off properties of the cohered water for a long time. Consequently, by using the precoated aluminum sheets in the fins of the heat exchanger, the adherence of frost can be sufficiently prevented or inhibited and the frost removal properties are also excellent.

### BRIEF DESCRIPTION OF THE DRAWINGS

FIG. 1 is an enlarged cross-sectional view of a precoated aluminum sheet, which has a hydrophilic-coating film formed on a substrate, according to working example 1.

FIG. 2 is a top view of the precoated aluminum sheet according to working example 1.

FIGS. 3A and 3B show explanatory diagrams according to working example 1, in which FIG. 3A is an explanatory diagram that shows a water droplet, having a small contact angle, on the hydrophilic-coating film, and FIG. 3B is an explanatory diagram that shows a water droplet, having a large contact angle, on the hydrophilic-coating film.

FIG. 4 is an explanatory diagram that shows, according to working example 1, a method of measuring a sliding angle.

FIG. 5 is an enlarged cross-sectional view of the precoated aluminum sheet having a primer layer between the substrate and the hydrophilic-coating film according to working example 1.

FIG. 6 is an oblique view of a heat exchanger according to working example 1.

### DETAILED DESCRIPTION OF THE INVENTION

Next, embodiments of a precoated aluminum sheet and a heat exchanger will be explained.

The precoated aluminum sheet has a hydrophilic-coating film formed on a substrate. The hydrophilic-coating film may be formed on one side of the substrate or on both sides. Preferably, the hydrophilic-coating film should be formed on both sides of the substrate. In this case, the fins for the heat exchanger composed of the precoated aluminum sheets can exhibit excellent hydrophilicity on both sides thereof and can exhibit excellent sheeting of condensed water. Consequently, the adherence of frost to the fins of the heat exchanger can be much better prevented and the frost removal properties can be much more improved.

With regard to the precoated aluminum sheet, the surface roughness Rz_{L} of the hydrophilic-coating film in the substrate rolling-parallel direction and the surface roughness Rz_{LT} of the hydrophilic-coating film in the substrate rolling-perpendicular direction preferably satisfy the relationships Rz_{L}≤1.5 μm, 0.3 μm≤Rz_{LT}≤2.5 μm, and Rz_{L}/Rz_{LT}≤0.9. The substrate rolling-parallel direction is the direction parallel to the rolling direction, and the rolling-perpendicular direction is the direction perpendicular to the rolling direction. It is noted that every surface roughness in the present specification indicates the maximum height roughness according to JIS B0601-2001.

If Rz_{L}>1.5 μm, then there is a risk that sheeting of condensed water will tend to decrease. In addition, there is a risk that frost will tend to adhere to the fins composed of precoated aluminum sheets and that removal of the adhered frost will become problematic. In addition, if Rz_{LT}<0.3 μm, then there is a risk that hydrophilicity will decrease. In addition, there is a risk that frost will tend to adhere to the fins. From the viewpoint of better preventing these, Rz_{LT}≥0.8 μm is more preferable, Rz_{LT}≥1 μm is yet more preferable, and Rz_{LT}≥1.5 μm is particularly preferable. In addition, if Rz_{LT}>2.5 μm, then there is a risk that frost will tend to adhere to the fins and removal of the adhered frost will become problematic. From the viewpoint of better preventing these, Rz_{LT}≤2.3 μm is more preferable, and Rz_{LT}≤1.8 μm is yet more preferable.

In addition, if Rz_{L}/Rz_{LT}>0.9, then there is a risk that hydrophilicity and/or sheeting of the cohered (condensed) water will tend to decrease. In addition, there is a risk that frost will tend to adhere to the fins and that removal of the adhered frost will become problematic. From the viewpoint of better preventing these, Rz_{L}/Rz_{LT}≤0.8 is more preferable, and Rz_{L}/Rz_{LT}≤0.7 is yet more preferable.

The contact angle of the water droplet with respect to the hydrophilic-coating film is preferably 25° or less. If the contact angle is greater than 25°, then there is a risk that hydrophilicity and sheeting of the cohered water will tend to decrease. In addition, there is a risk that frost will tend to adhere to the fins and removal of adhered frost will become problematic. From the viewpoint of better preventing these, the contact angle is more preferably 20° or less and yet more preferably 15° or less.

In addition, the sliding angle of the water droplet, in the rolling-parallel direction of the substrate, with respect to the hydrophilic-coating film is preferably 20° or less. If the sliding angle is greater than 20°, then there is a risk that hydrophilicity and sheeting of the cohered water will tend to decrease. In addition, there is a risk that frost will tend to adhere to the fins and removal of the adhered frost will become problematic. From the viewpoint of better preventing these, the sliding angle is more preferably 15° or less and yet more preferably 10° or less.

The average film thickness of the hydrophilic-coating film is preferably 0.3 μm or more and 1.5 μm or less. In this case, it is possible to much better prevent a decrease in sheeting of cohered water. In addition, the adherence of frost is better prevented and it becomes easier to better remove adhered frost. Furthermore, there is the possibility of increasing the film thickness beyond the above-mentioned range; however, even if the film thickness is increased excessively, virtually no improvement effect is obtained and the weight of the fins composed of the precoated aluminum sheets becomes large, which is not preferable. The average film thickness of the hydrophilic-coating film is more preferably 0.5 μm or more and yet more preferably 0.6 μm or more.

With regard to the hydrophilic-coating film, a hydrophilic polymer (A) is cross linked by a cross-linking agent (B). At least one type of polymer selected from the group consisting of acrylic-modified epoxy resin, acrylic-cellulose resin, cellulose-melamine resin, cellulose-acetate resin, and polyoxyalkylene resin can be used as the hydrophilic polymer (A). At least one selected from the group consisting of isocyanate, blocked polyisocyanate, and carbodiimide can be used as the cross-linking agent (B). By using a combination of these, the surface roughness Rz_{L} and the surface roughness Rz_{LT} satisfy the above-mentioned desired relationships, and it becomes easy to achieve a hydrophilic film in which the contact angle and the sliding angle are within the above-mentioned desired ranges.

The acrylic-modified epoxy resin is an epoxy resin that has been modified with an acrylic. The acrylic-modified epoxy resin can be obtained by, for example, the following methods (1)-(3). That is, (1) an acrylic-epoxy resin can be obtained by a method in which a polymerizable unsaturated monomer, such as an acrylic monomer, is polymerized with and grafted onto an epoxy resin by a hydrogen abstraction reaction. (2) The acrylic-modified epoxy resin can also be obtained by esterifying a carboxyl-group-containing polymerizable unsaturated monomer, such as a carboxyl-group-containing acrylic monomer, with the epoxy group of an epoxy resin and causing the acrylic monomer to polymerize at the double bond introduced in the epoxy resin. (3) An acrylic-modified epoxy resin can also be obtained by reacting an epoxy resin and a carboxyl-group-containing acrylic resin. The acrylic-modified epoxy resin manufactured by method (3) is preferable. In this case, the adherence of frost can be better prevented and the corrosion resistance of the hydrophilic-coating film is improved.

The hydrophilic polymerizing agent and the cross-linking agent are mixed, and are coated onto at least one surface of the substrate; a cross-linking reaction that creates amide groups can be initiated by heating. As a result, by making a deterioration in hydrophilicity less likely to happen, which deterioration is caused by the resin, which has functional groups that exhibit hydrophilicity, flowing out to the condensed water during use, a hydrophilic-coating film that better excels in durability of hydrophilicity and sheeting of cohered (condensed) water is obtained.

The substrate is composed of sheet-shaped aluminum. In the present specification, the term “aluminum” includes not only pure aluminum but also aluminum alloys. The surface roughness Rz of the substrate in the rolling-perpendicular direction is preferably 0.5 μm or more and 3 μm or less. In this case, it becomes easier for the surface roughness Rz_{L} and the surface roughness Rz_{LT} of the hydrophilic-coating film to better satisfy the above-mentioned desired relationships. From a similar viewpoint, the surface roughness Rz of the substrate in the rolling-perpendicular direction is preferably 1 μm or more and 2.5 μm or less and is yet more preferably 1.2 μm or more and 2 μm or less.

The precoated aluminum sheets are used in the fins of the heat exchanger. In at least part of each fin, the rolling-parallel direction of the substrate is preferably disposed in the vertical direction. In this case, the above-mentioned excellent features of the precoated aluminum sheet can manifest sufficiently. As a result, in the heat exchanger, the adherence of frost can be more sufficiently prevented and the frost can be more sufficiently removed. With regard to the phrase “the rolling-parallel direction is the vertical direction” mentioned above, it is noted that it is only necessary that the rolling-parallel direction and the vertical direction coincide with each other in external view; however, the rolling-parallel direction and the vertical direction do not necessarily have to coincide, and some tilt is allowed. The tilt angle can be set to any angle as long as the cohered water that is adhered to the fin flows down.

Normally, when the precoated aluminum sheet is being formed into the fins for the heat exchanger, the rolling-parallel direction of the substrate becomes the longitudinal direction of the sheet-shaped fins (hereinbelow, called plate fins), and the longitudinal direction of the plate fins is disposed perpendicularly (that is, vertically) in the heat exchanger. That is, the rolling-parallel direction of the precoated aluminum sheet becomes the perpendicular direction in the heat exchanger. Accordingly, by imparting satisfactory water sheeting properties in the rolling-parallel direction as in the above-mentioned precoated aluminum sheet, cohered water (also called, for example, condensed water droplets) in the heat exchanger is satisfactorily exhausted.

The precoated aluminum sheet can be manufactured as follows. First, a substrate composed of aluminum is manufactured as follows. Specifically, an ingot is manufactured by casting aluminum (i.e., a casting process). Subsequently, a coil (i.e., an aluminum sheet coiled into a roll shape) is manufactured by heating and rolling the ingot (i.e., a hot-rolling process). Next, the post-hot-rolled coil is cold rolled (i.e., a cold-rolling process). Thus, a substrate composed of aluminum can be obtained. Furthermore, the maximum roughness of the cold-rolled coil in the rolling-perpendicular direction is preferably set to 0.5 μm or more and 3.0 μm or less, as described above. To adjust the surface roughness Rz of the substrate in the rolling-perpendicular direction to the above-mentioned desired range, various rolling conditions, such as the maximum roughness of the cold-rolling rollers in the rolling-perpendicular direction, the rolling speed, the lubricating oil, etc., should be adjusted appropriately. To improve cold rollability, annealing (i.e., an annealing process) may be performed in the course of the cold-rolling process.

Contamination, such as rolling oil, can be removed from the surfaces of the post-cold-rolled coil using an alkaline degreaser, and the surfaces can be etched. Thereafter, a chemical-conversion coating can be formed on the coil surfaces using a chemical-conversion-treatment agent. Chromate treatment, zirconia treatment, and the like are examples of the chemical-conversion treatment. By forming the chemical-conversion coating, adhesion between the substrate and the hydrophilic-coating film and between the substrate and a primer layer, which is described below, can be improved. Subsequently, the coil surfaces can be coated, by roll coating, with a hydrophilic paint for forming a hydrophilic-coating film, thereby forming the hydrophilic-coating film. A paint containing, for example, the hydrophilic polymer (A) and the cross-linking agent (B) described above is used as the hydrophilic paint. The hydrophilic paint can further contain a solvent, various additives, etc.

The viscosity of the hydrophilic paint is preferably set to 5-15 s by taking a measurement using a Ford Cup No. 4 as stipulated in JIS K5400. In this case, it becomes easier to form the hydrophilic-coating film in which the surface roughness Rz_{L} and the surface roughness Rz_{LT} satisfy the above-mentioned desired relationships. After coating with the hydrophilic paint, the hydrophilic polymer (A) can be cross-linked by the cross-linking agent (B) by heating for several seconds at a temperature of approximately 200° C. By cross-linking the hydrophilic polymer (A), a resin having functional groups that exhibit hydrophilicity tends not to flow out to water. Consequently, the durability of hydrophilicity can be further improved.

In addition, before coating with the water-based paint, it is preferable to form a primer layer. In this case, the primer layer is formed between the substrate and the hydrophilic-coating film, and thereby adhesion between the substrate and the hydrophilic-coating film can be further improved. The primer layer can be formed of at least one selected from the group consisting of a urethane-based primer, an acrylic-based primer, and an epoxy-based primer. The thickness of the primer is preferably 0.3 μm or more and 3 μm or less.

Precoated aluminum sheets are used in the manufacture of the heat exchanger as, for example, described below. Specifically, first, precoated aluminum sheets are strip cut from the coil to obtain a plurality of fins. Subsequently, the fins are subject to slit (hole) formation, louver molding, and collar formation using a press. Subsequently, metal tubes disposed at prescribed locations are passed through the holes provided in the fins so as to stack the fins. After stacking, tube-expanding plugs are inserted into the metal tubes to enlarge the outer diameter of the metal tubes, and thereby the metal tube and the fins are caused to closely contact each other. Thus, the heat exchanger can be obtained.

### WORKING EXAMPLES

### Working Example 1

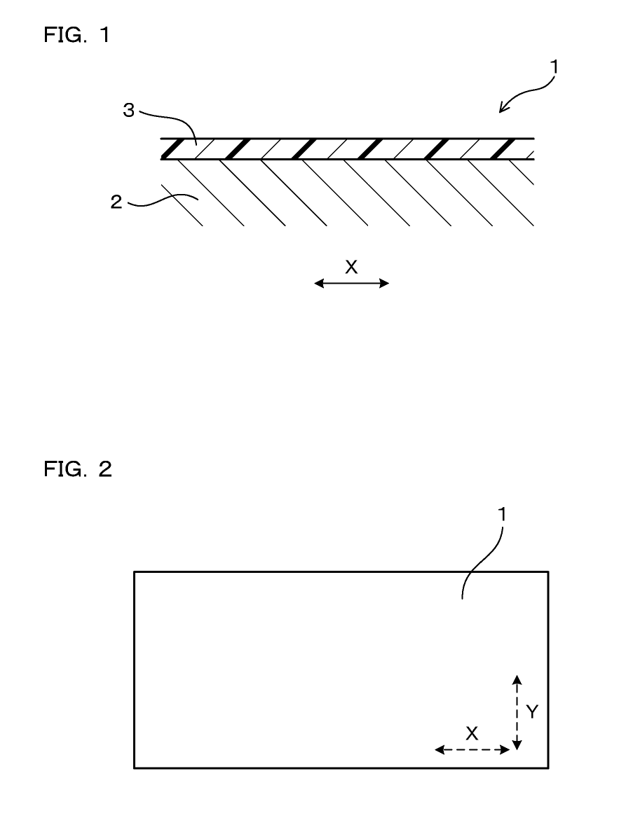

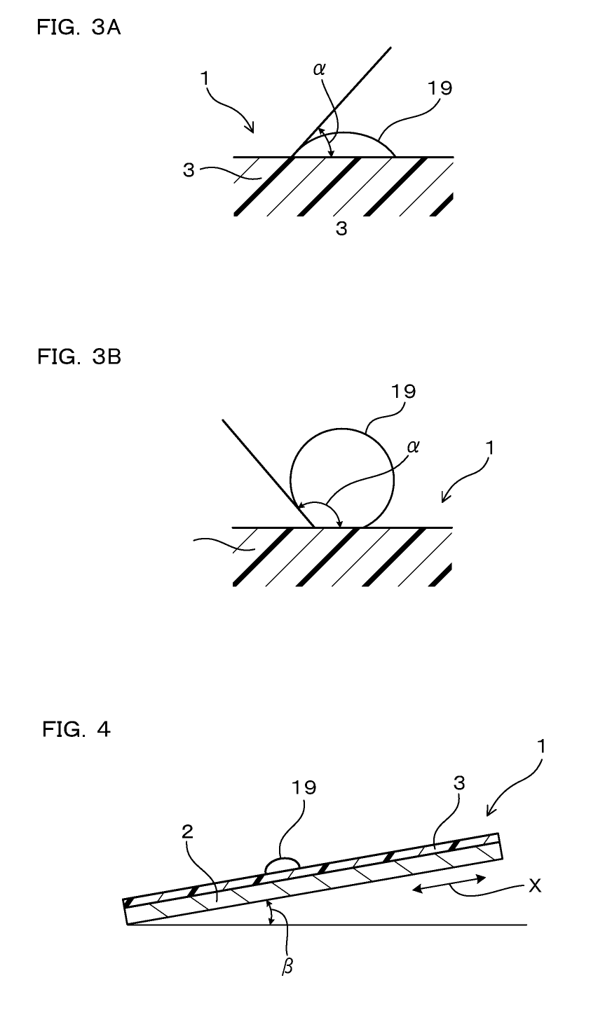

In the present example, multiple precoated aluminum sheets (specifically, sample E1 to sample E21 and sample C1 to sample C9) pertaining to working examples and comparative examples were prepared, and their characteristics were compared and evaluated. As shown in FIG. 1, a precoated aluminum sheet 1 according to the working examples comprises: a substrate 2 composed of aluminum; and a hydrophilic-coating film 3 formed on at least one surface thereof. As shown in FIG. 1 and FIG. 2, with regard to the precoated aluminum sheet 1, the surface roughness Rz_{L} of the hydrophilic-coating film 3 in a rolling-parallel direction X of the substrate 2 and the surface roughness Rz_{LT} of the hydrophilic-coating film 3 in a rolling-perpendicular direction Y of the substrate 2 satisfy the relationships Rz_{L}≤1.5 μm, 0.3 μm≤Rz_{LT}≤2.5 μm, and Rz_{L}/Rz_{LT}≤0.9. As shown in FIG. 3(a), the contact angle α of a water droplet 19 with respect to the hydrophilic-coating film 3 is 25° or less. In addition, as shown in FIG. 4, the sliding angle β of the water droplet 19, in the rolling-parallel direction X of the substrate 1, with respect to the hydrophilic-coating film 3 is 20° or less.

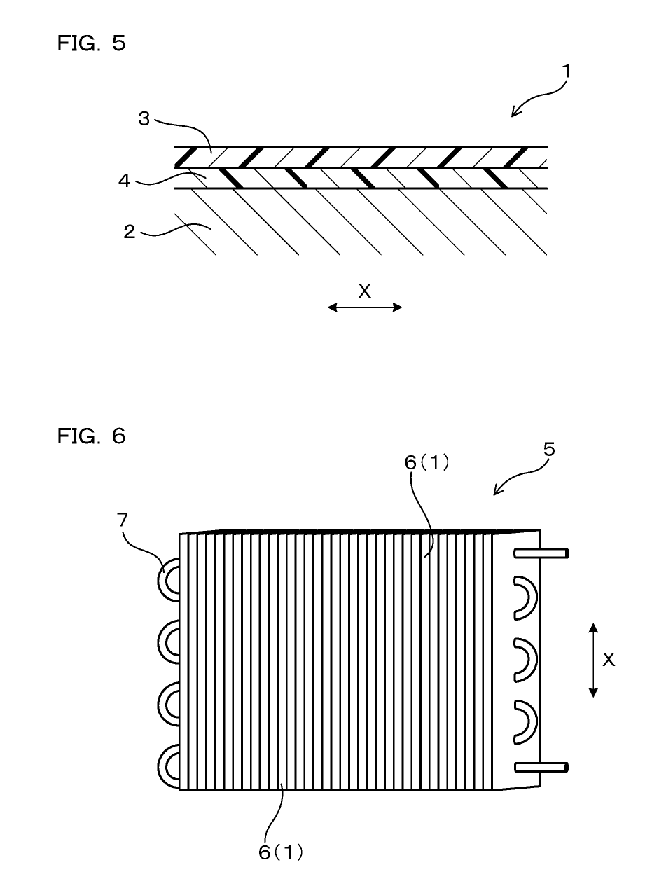

In the present example, multiple precoated aluminum sheets (i.e., sample E1 to sample E21 and sample C1 to sample C9) having differing surface roughnesses Rz_{L}, surface roughnesses Rz_{LT}, water droplet contact angles α, water droplet sliding angles β, and the like were manufactured by modifying the substrate surface roughness Rz, the type of chemical-conversion treatment, the presence and type of primer layer, the composition and the viscosity of the hydrophilic paint used in the manufacture of the hydrophilic-coating film, the film thickness of the hydrophilic-coating film, and the like as shown in Table 1 and Table 2. With regard to the hydrophilic paint, the hydrophilic polymer, the type of cross-linking agent, the mixing ratio, and the like were modified as shown in Table 1 and Table 2. The amount of the chemical-conversion coating formed was 20 mg/m² in every case. In addition, in every precoated aluminum sheet, the hydrophilic-coating film was formed on both sides of the substrate. In addition, the precoated aluminum sheets 1 in sample E19 to sample E21 had a primer layer 4 between the substrate 2 and the hydrophilic-coating film 3, as shown in FIG. 5. In the other precoated aluminum sheets 1, there was no primer layer, and the hydrophilic-coating film 3 was formed on the substrate 2 as shown in FIG. 1. The various physical properties and characteristics of sample E1 to sample E18 were measured as below.

(A) Measurement of Surface Roughnesses Rz, Rz_{L}, Rz_{LT}

The surface roughnesses were measured using a laser microscope LEXT® OLS-3000 manufactured by Olympus® Corporation. Specifically, first, the magnification of the objective lens of the microscope was set to 100 times, the scan pitch of the laser light was set to 0.05 μm, a surface of each sample was scanned, and thereby surface data was obtained. Subsequently, that surface data was analyzed in specified directions (specifically, in the rolling-parallel direction and the rolling-perpendicular direction), and the roughnesses were calculated. The direction was determined based on the rolling marks, which were recognized by magnification. The measurement length was 130 μm; in the rolling-parallel direction, measurements were performed at seven locations in one visual field; in the rolling-perpendicular direction, measurements were performed at seven locations in each of two visual fields (i.e., a total of 14 locations).

(B) Film Thicknesses of the Hydrophilic-Coating Film and the Primer Layer

Film thickness was measured, using an eddy-current-type coating thickness gauge, at ten arbitrary locations on the surface of the hydrophilic-coating film of each precoated aluminum sheet, and an average film thickness was derived from the arithmetic mean of these measurement values. In addition, in the case of a precoated aluminum sheet having the primer layer between the substrate and the hydrophilic-coating film, film thickness was measured, using the same eddy-current-type coating thickness gauge described above, for the coated aluminum sheet in which the primer layer alone was formed and for the precoated aluminum sheet in which the hydrophilic-coating film was further formed on the primer layer. Furthermore, the average film thickness of the primer layer could be obtained from the measurement results of the coated aluminum sheet, and the average film thickness of the hydrophilic-coating film was derived from the difference between the measurement results (the average value) of the precoated aluminum sheet and the measurement results (the average value) of the coated aluminum sheet.

(C) Contact Angle

A water droplet 19 having a volume of 2 μl was dropped onto the hydrophilic-coating film 3 of each of the precoated aluminum sheets 1 (refer to FIGS. 3A and 3B). Then, the contact angle α of the water droplet 19 with respect to the hydrophilic-coating film 3 was measured. FIG. 3A shows the case in which the contact angle α is an acute angle, and FIG. 3B shows the case in which the contact angle α is an obtuse angle. The contact angles immediately after the formation of the hydrophilic-coating films are shown in Table 1 and Table 2.

(D) Sliding Angle

As shown in FIG. 4, a water droplet 19 having a volume of 10 μl was dropped, using a syringe, onto the hydrophilic-coating film 3 of each of the precoated aluminum sheets 1, and one end of each of the precoated aluminum sheets 1 was lifted up, and thereby each precoated aluminum sheet 1 was tilted. Then, when the water droplet 19 began to descend, the angle formed between the precoated aluminum sheet 1 and the horizontal plane was measured. This angle is the sliding angle β. It is noted that, as shown in FIG. 4, in the sliding-angle measurement test, the precoated aluminum sheet 1 is tilted such that the rolling-parallel direction X is inclined. The sliding angles β immediately after the formation of the hydrophilic-coating films are shown in Table 1 and Table 2.

Next, each precoated aluminum sheet was evaluated, as follows, for frost-formation preventability, defrosting properties, hydrophilicity durability, sheeting durability, corrosion resistance, and moisture resistance. In the evaluations of frost-formation preventability and defrosting properties, a heat exchanger for evaluation, which comprised fins composed of precoated aluminum sheets, was used.

As shown in FIG. 6, the heat exchanger 5 is a cross-fin-tube type and comprises: numerous plate fins 6, each composed of the precoated aluminum sheet 1, and a metal tube 7 that passes through these and is for transferring heat. The plate fins 6 are spaced apart by a prescribed spacing and are disposed in parallel. The width (W) of the plate fins is 25.4 mm; the height (H) is 290 mm; the fin-stacking pitch (P) is 1.4 mm; the width (D) of the entire heat exchanger is 300 mm. The height direction of the plate fin 6 is the rolling-parallel direction X of the substrate. There are two columns of the metal tube 7 in the width (W) of the plate fins, and there are 14 stages of the metal tube 7 in the plate-fin height (H). It is noted that, for the simplicity of illustration, several of the metal tubes 7 are not shown in FIG. 6. In addition, the metal tube is a copper tube having a helical groove on its inner surface. The dimensions of the metal tube are outer diameter: 7.0 mm, bottom-wall thickness: 0.45 mm, fin height: 0.20 mm, fin vertical angle: 15.0°, and helix angle: 10.0°.

Each of the heat exchangers 5 was prepared as follows. First, assembly holes (not shown), each having a fin-collar part with a height of 1-4 mm for inserting metal tubes 7 therethrough and fixing such, were formed by press working the plate fins 6. Each plate fin 6 was composed of the above-described precoated aluminum sheets 1 having a thickness of 0.1 mm. After stacking the plate fins 6, separately prepared metal tubes 7 were inserted through the assembly holes. A copper tube having a groove formed on its inner surface by rolling or the like was cut to a standard length and hairpin bent, to form the metal tubes 7. Next, by inserting tube-expanding plugs into one end of the metal tubes 7 and widening the outer diameter of the metal tubes 7, the metal tubes 7 were secured to the plate fins 6. After the tube-expanding plugs were removed, U-bent tubes were joined, by braising, to the metal tubes 7, and thereby each of the heat exchangers 5 was obtained.

(E1) Frost-Formation Preventability

Frost-formation preventability was evaluated using the heat exchangers 5 prepared as described above (refer to FIG. 6). Specifically, the heat exchangers 5 comprising the fins 6 composed of the precoated aluminum sheets 1 of the sample E1 to sample E21 and sample C1 to sample C9 were installed in an environment in which the atmospheric temperature (i.e., dry-bulb temperature) was 2° C. and the wet-bulb temperature was 1° C. Inside the metal tubes 7, which is for transferring heat, of the heat exchangers 5, coolant (i.e., a heat-exchanging medium) having a temperature of −5° C. and a degree of superheat of 2° C. at the outlet flowed at a flow velocity of 20 kg/h. Meanwhile, a frost-forming operation of the heat exchanger 5 was performed under the condition in which the inlet wind speed of the circulating draft was set to 1.5 m/s. Furthermore, ventilation resistance was measured based on the pressure differential between the inlet side and the outlet side of the heat exchanger 5, and operation was performed until the ventilation resistance became 500 Pa. At the point in time when the ventilation resistance became 500 Pa, operation was switched to a defrosting operation, and coolant heated to approximately 20° C. was circulated in the metal tube 7 for 2 min. The inlet wind speed of the draft circulated to the heat exchanger during the defrosting operation was set to 0 m/s. The frost-forming operation and the defrosting operation were repeated for five cycles, and frost-formation preventability was evaluated during the fifth cycle of the frost-forming operation. In addition, the average amount of heat exchanged was measured by measuring the temperature and the pressure of the coolant at the coolant inlet and the coolant outlet of the heat exchanger during the fifth cycle test and by measuring the enthalpy differential of the coolant between the coolant inlet and the coolant outlet. Furthermore, the operation time until the ventilation resistance of the fifth cycle became 500 Pa was compared with the heat exchanger comprising the fins composed of sample C6. If the operation time extended 10 min or longer beyond that of the sample C6 heat exchanger, then it was evaluated as “□”; and if the operation time extended 5 min or longer and less than 10 min, then it was evaluated as “◯” In addition, if the extension of the operation time was from 0 to shorter than 5 min, then it was evaluated as “Δ”; and if the operation time was shorter, then it was evaluated as “×.”

(E2) Defrosting Property

An evaluation similar to that of frost-formation preventability was performed; if the remaining ice after defrosting was 20% or less of the total frost amount, then it was evaluated as “□”; if the remaining ice after defrosting was more than 20% and 40% or less of the total frost amount, then it was evaluated as “◯”; if the remaining ice after defrosting was more than 40% and 80% or less of the total frost amount, then it was evaluated as “Δ”; and if the remaining ice after defrosting was more than 80% of the total frost amount, then it was evaluated as “×.”

(F) Hydrophilicity Durability

Hydrophilicity durability was evaluated by measuring the contact angle after a deterioration trial. First, a cycle in which the precoated aluminum sheet was immersed in ion-exchanged water for 2 min and then dried by air blowing for 6 min was performed 300 times (the deterioration (wear) trial). Subsequently, the contact angle of the water droplet after this deterioration (wear) trial was measured by the method described above. If the contact angle after the deterioration trial was 10° or lower, then it was evaluated as “□”; if it was above 10° and 25° or lower, then it was evaluated as “◯”; if it was above 25° and 30° or lower, then it was evaluated as “Δ”; and if it was above 30°, then it was evaluated as “×.”

(G) Sheeting Durability

Sheeting durability was evaluated by measuring the sliding angle after the deterioration (wear) trial. The deterioration trial is similar to that of the hydrophilicity durability described above, and the sliding angle measuring method is as described above. If the sliding angle after the deterioration trial was 10° or lower, then it was evaluated as “□”; if it was above 10° and 20° or lower, then it was evaluated as “◯”; if it was above 20° and 30° or lower, then it was evaluated as “Δ”; and if it was above 30°, it was evaluated as “×.”

(H) Corrosion Resistance

Using each precoated aluminum sheet, the salt spray test stipulated in JIS Z2371 was performed for 500 h, and post-test corrosion resistance was evaluated. After the test, if a brown discoloring did not appear on the surface of the hydrophilic-coating film, then it was evaluated as “◯”; and if a discoloring appeared, then it was evaluated as “×.”

(I) Moisture Resistance

Using each precoated aluminum sheet, the moisture-resistance test stipulated in JIS H4001 was performed for 960 h, and post-test moisture resistance was evaluated. After the test, if a brown discoloring did not appear on the surface of the hydrophilic-coating film, then it was evaluated as “◯”; and if a discoloring appeared, then it was evaluated as “×.”

TABLE 1

| | | | | | Hydrophilic-Coating Film | | | |
|---|---|---|---|---|---|---|---|---|
| | Substrate | | | | Hydrophilic | | Hydrophilic | |
| | | Chemical- | Primer Layer | | Polymer 1 | | Polymer 2 | |
| | Surface | Conversion | | Film | | Content | | Content |
| Sample | Roughness | Treatment | | Thickness | | (parts by | | (parts by |
| No. | Rz (μm) | Type | Type | (μm) | Type | mass) | Type | mass) |
| E1 | 1.6 | Chromate | — | — | AE | 75 | AC | 5 |
| | | Treatment | | | | | | |
| E2 | 1.6 | Chromate | — | — | AE | 65 | AC | 5 |
| | | Treatment | | | | | | |
| E3 | 1.6 | Chromate | — | — | AE | 55 | AC | 5 |
| | | Treatment | | | | | | |
| E4 | 2.3 | Chromate | — | — | AE | 80 | AC | 10 |
| | | Treatment | | | | | | |
| E5 | 2.3 | Chromate | — | — | AE | 70 | AC | 10 |
| | | Treatment | | | | | | |
| E6 | 0.5 | Chromate | — | — | AE | 60 | AC | 10 |
| | | Treatment | | | | | | |
| E7 | 1.6 | Chromate | — | — | AE | 60 | — | — |
| | | Treatment | | | | | | |
| E8 | 1.6 | Chromate | — | — | AE | 70 | — | — |
| | | Treatment | | | | | | |
| E9 | 1.6 | Chromate | — | — | AE | 80 | — | — |
| | | Treatment | | | | | | |
| E10 | 1.6 | Chromate | — | — | AC | 70 | — | — |
| | | Treatment | | | | | | |
| E11 | 1.6 | Chromate | — | — | CM | 70 | — | — |
| | | Treatment | | | | | | |
| E12 | 1.6 | Chromate | — | — | CA | 70 | — | — |
| | | Treatment | | | | | | |
| E13 | 1.6 | Chromate | — | — | AE | 70 | — | — |
| | | Treatment | | | | | | |
| E14 | 1.6 | Chromate | — | — | AE | 70 | — | — |
| | | Treatment | | | | | | |
| E15 | 1.6 | Zirconia | — | — | AE | 75 | AC | 5 |
| | | Treatment | | | | | | |
| E16 | 1.6 | Chromate | — | — | AE | 75 | AC | 5 |
| | | Treatment | | | | | | |
| E17 | 1.6 | Chromate | — | — | AE | 75 | AC | 5 |
| | | Treatment | | | | | | |
| E18 | 1.5 | Chromate | — | — | AE | 75 | AC | 5 |
| | | Treatment | | | | | | |
| E19 | 1.6 | Chromate | Urethane | 1.2 | AE | 75 | AC | 5 |
| | | Treatment | Type | | | | | |
| E20 | 1.6 | Chromate | Acrylic | 1.2 | AE | 75 | AC | 5 |
| | | Treatment | Type | | | | | |
| E21 | 1.6 | Chromate | Epoxy | 1.2 | AE | 75 | AC | 5 |
| | | Treatment | Type | | | | | |

| | Hydrophilic-Coating Film | | | | | | | |
|---|---|---|---|---|---|---|---|---|
| | Cross-Linking | | | | | | | |
| | Agent | | Surface | | | | | |
| | | Content | Roughness | | | Contact | Sliding | Film |
| Sample | | (parts by | Rz_{L} | Rz_{LT} | Rz_{L}/ | Angle | Angle | Thickness |
| No. | Type | mass) | (μm) | (μm) | Rz_{LT} | (°) | (°) | (μm) |
| E1 | A | 20 | 1.3 | 1.6 | 0.81 | 10 | 10 | 0.8 |
| E2 | A | 30 | 0.6 | 1.6 | 0.38 | 12 | 8 | 0.8 |
| E3 | A | 40 | 0.2 | 1.6 | 0.13 | 14 | 12 | 0.8 |
| E4 | A | 10 | 0.6 | 2.3 | 0.26 | 5 | 13 | 0.8 |
| E5 | A | 20 | 0.6 | 2.3 | 0.26 | 10 | 10 | 0.8 |
| E6 | A | 30 | 0.2 | 0.3 | 0.67 | 15 | 5 | 0.8 |
| E7 | A | 40 | 0.6 | 1.6 | 0.38 | 12 | 8 | 0.8 |
| E8 | A | 30 | 0.6 | 1.6 | 0.38 | 12 | 8 | 0.8 |
| E9 | A | 20 | 0.6 | 1.6 | 0.38 | 12 | 8 | 0.8 |
| E10 | A | 30 | 0.6 | 1.6 | 0.38 | 20 | 5 | 0.8 |
| E11 | A | 30 | 0.6 | 1.6 | 0.38 | 15 | 5 | 0.8 |
| E12 | A | 30 | 0.6 | 1.6 | 0.38 | 25 | 15 | 0.8 |
| E13 | B | 30 | 0.6 | 1.6 | 0.38 | 10 | 20 | 0.8 |
| E14 | C | 30 | 0.6 | 1.6 | 0.38 | 10 | 20 | 0.8 |
| E15 | A | 20 | 1.0 | 1.6 | 0.63 | 10 | 10 | 0.8 |
| E16 | A | 20 | 1.0 | 1.6 | 0.63 | 20 | 20 | 0.3 |
| E17 | A | 20 | 1.0 | 1.6 | 0.63 | 10 | 10 | 1.5 |
| E18 | A | 20 | 1.0 | 1.6 | 0.63 | 10 | 10 | 2 |
| E19 | A | 20 | 1.0 | 1.6 | 0.63 | 10 | 10 | 0.8 |
| E20 | A | 20 | 1.0 | 1.6 | 0.63 | 10 | 10 | 0.8 |
| E21 | A | 20 | 1.0 | 1.6 | 0.63 | 10 | 10 | 0.8 |

AC: Acrylic-cellulose resin
CM: Cellulose-melamine resin
CA: Cellulose-acetate resin
Cross-Linking Agent A: Isocyanate
Cross-Linking Agent B: Blocked polyisocyanate
Cross-Linking Agent C: Melamine

TABLE 2

| | | | Hydrophilic-Coating Film | | | | | | | | | | | |
|---|---|---|---|---|---|---|---|---|---|---|---|---|---|---|
| | Substrate | | Hydrophilic | | Hydrophilic | | Cross-Linking | | | | | | | |
| | | Chemical- | Polymer 1 | | Polymer 2 | | Agent | | Surface | | | | | Film |
| | Surface | Conversion | | Content | | Content | | Content | Roughness | | | Contact | Sliding | Thick- |
| Sample | Roughness | Treatment | | (parts by | | (parts by | | (parts by | Rz_{L} | Rz_{LT} | Rz_{L}/ | Angle | Angle | ness |
| No. | Rz(μm) | Type | Type | mass) | Type | mass) | Type | mass) | (μm) | (μm) | Rz_{LT} | (°) | (°) | (μm) |
| C1 | 0.3 | Chromate | AE | 75 | AC | 5 | A | 20 | 0.2 | 0.16 | 1.25 | 30 | 5 | 0.8 |
| | | Treatment | | | | | | | | | | | | |
| C2 | 3.5 | Chromate | AE | 75 | AC | 5 | A | 20 | 1.5 | 2.8 | 0.54 | 5 | 20 | 0.8 |
| | | Treatment | | | | | | | | | | | | |
| C3 | 1.5 | Chromate | AE | 85 | AC | 10 | — | — | 1.0 | 1.6 | 0.63 | 20 | 25 | 0.3 |
| | | Treatment | | | | | | | | | | | | |
| C4 | 1.5 | Chromate | AE | 75 | AC | 5 | A | 20 | 1.0 | 1.6 | 0.63 | 20 | 25 | 0.2 |
| | | Treatment | | | | | | | | | | | | |
| C5 | 1.5 | — | AE | 75 | AC | 5 | A | 20 | 1.0 | 1.6 | 0.63 | 20 | 25 | 0.3 |
| C6 | 1.5 | Chromate | AR | 75 | — | — | C | 25 | 3.0 | 3.0 | 1.00 | 15 | 15 | 0.8 |
| | | Treatment | | | | | | | | | | | | |
| C7 | 1.5 | Chromate | FC | 100 | — | — | — | — | 1.0 | 1.6 | 0.63 | 120 | 10 | 0.8 |
| | | Treatment | | | | | | | | | | | | |
| C8 | 1.5 | Chromate | AE | 75 | AC | 5 | A | 20 | 0.8 | 0.8 | 1 | 15 | 25 | 0.8 |
| | | Treatment | | | | | | | | | | | | |
| C9 | 1.5 | Chromate | AE | 75 | AC | 5 | A | 20 | 1.6 | 2.3 | 0.7 | 15 | 25 | 0.8 |
| | | Treatment | | | | | | | | | | | | |

AE: Acrylic-modified epoxy resin
AR: Acrylic resin
FC: Fluororesin
AC: Acrylic-cellulose resin
Cross-Linking Agent A: Isocyanate
Cross-Linking Agent C: Melamine

TABLE 3

| | Frost- | | | | | |
|---|---|---|---|---|---|---|
| Sample | Formation | Defrosting | Hydrophilic | Sheeting | Corrosion | Moisture |
| No. | Preventability | Property | Durability | Durability | Resistance | Resistance |
| E1 | ⊚ | ⊚ | ⊚ | ⊚ | ◯ | ◯ |
| E2 | ⊚ | ⊚ | ◯ | ⊚ | ◯ | ◯ |
| E3 | ⊚ | ◯ | ◯ | ◯ | ◯ | ◯ |
| E4 | ⊚ | ◯ | ⊚ | ◯ | ◯ | ◯ |
| E5 | ⊚ | ⊚ | ⊚ | ◯ | ◯ | ◯ |
| E6 | ◯ | ⊚ | ◯ | ⊚ | ◯ | ◯ |
| E7 | ⊚ | ⊚ | ◯ | ⊚ | ◯ | ◯ |
| E8 | ⊚ | ⊚ | ◯ | ⊚ | ◯ | ◯ |
| E9 | ⊚ | ⊚ | ◯ | ⊚ | ◯ | ◯ |
| E10 | ◯ | ⊚ | ◯ | ◯ | ◯ | ◯ |
| E11 | ◯ | ⊚ | ◯ | ◯ | ◯ | ◯ |
| E12 | ◯ | ◯ | ◯ | ◯ | ◯ | ◯ |
| E13 | ⊚ | ◯ | ⊚ | ⊚ | ◯ | ◯ |
| E14 | ⊚ | ◯ | ⊚ | ⊚ | ◯ | ◯ |
| E15 | ⊚ | ⊚ | ⊚ | ⊚ | ◯ | ◯ |
| E16 | ◯ | ⊚ | ◯ | ◯ | ◯ | ◯ |
| E17 | ⊚ | ⊚ | ⊚ | ⊚ | ◯ | ◯ |
| E18 | ⊚ | ⊚ | ⊚ | ◯ | ◯ | ◯ |
| E19 | ⊚ | ⊚ | ⊚ | ⊚ | ◯ | ◯ |
| E20 | ⊚ | ⊚ | ⊚ | ⊚ | ◯ | ◯ |
| E21 | ⊚ | ⊚ | ⊚ | ⊚ | ◯ | ◯ |
| C1 | Δ | ⊚ | Δ | ⊚ | ◯ | ◯ |
| C2 | Δ | Δ | ⊚ | ⊚ | ◯ | ◯ |
| C3 | ◯ | Δ | X | X | X | X |
| C4 | ◯ | Δ | X | X | X | X |
| C5 | ◯ | X | X | X | X | X |
| C6 | Δ | ◯ | X | X | ◯ | ◯ |
| C7 | ⊚ | X | X | X | ◯ | ◯ |
| C8 | Δ | Δ | ◯ | X | ◯ | ◯ |
| C9 | Δ | Δ | ◯ | X | ◯ | ◯ |

1. A precoated aluminum sheet for a fin of a heat exchanger comprising:
a substrate composed of aluminum; and
a hydrophilic-coating film formed on at least one surface of the substrate; wherein:
a surface roughness Rz_{L} of the hydrophilic-coating film in a rolling-parallel direction of the substrate and a surface roughness Rz_{LT} of the hydrophilic-coating film in a rolling-perpendicular direction of the substrate satisfy the relationships Rz_{L}≤1.5 μm, 0.3 μm≤RZ_{LT}≤2.5 μm, and Rz_{L}/Rz_{LT}≤0.9; and
a contact angle of a water droplet with respect to the hydrophilic-coating film is 25° or lower, and a sliding angle of the water droplet in the rolling-parallel direction of the substrate is 20° or lower.

2. The precoated aluminum sheet according to claim 1, wherein a surface roughness Rz of the substrate in the rolling-perpendicular direction is 0.5 μm or more and 3 μm or less.

3. The precoated aluminum sheet according to claim 1, wherein an average film thickness of the hydrophilic-coating film is 0.3 μm or more and 1.5 μm or less.

4. The precoated aluminum sheet according to claim 1, wherein:
the hydrophilic-coating film is composed of a resin having an amide group, in which a hydrophilic polymer has been cross-linked by a cross-linking agent;
the hydrophilic polymer is composed of at least one selected from the group consisting of acrylic-modified epoxy resin, acrylic-cellulose resin, cellulose-melamine resin, cellulose-acetate resin, and polyoxyalkylene resin; and
the cross-linking agent is composed of at least one selected from the group consisting of isocyanate, blocked polyisocyanate, and carbodiimide.

5. The precoated aluminum sheet according to claim 1, wherein:
a primer layer is formed between the substrate and the hydrophilic-coating film;
the primer layer is composed of at least one selected from a urethane-based primer, an acrylic-based primer, and an epoxy-based primer; and
an average film thickness of the primer layer is 0.3 μm or more and 3 μm or less.

6. A heat exchanger comprising a fin composed of the precoated aluminum sheet according to claim 1.

7. The heat exchanger according to claim 6, wherein at least part of the fin is disposed such that the rolling-parallel direction of the substrate is the vertical direction.

8. The precoated aluminum sheet according to claim 1, wherein 0.8 μm≤Rz_{LT}≤2.3 μm, and Rz_{L}/Rz_{LT}≤0.8.

9. The precoated aluminum sheet according to claim 1, wherein 1 μm≤Rz_{LT}≤1.8 μm, and Rz_{L}/Rz_{LT}≤0.7.

10. The precoated aluminum sheet according to claim 1, wherein the contact angle is 20° or lower, and the sliding angle is 15° or lower.

11. The precoated aluminum sheet according to claim 1, wherein the contact angle is 15° or lower, and the sliding angle is 10° or lower.

12. The precoated aluminum sheet according to claim 4, wherein the hydrophilic polymer is composed of acrylic-modified epoxy resin.

13. The precoated aluminum sheet according to claim 2, wherein the surface roughness Rz of the substrate in the rolling-perpendicular direction is 1.2 μm or more and 2 μm or less.

14. The precoated aluminum sheet according to claim 13, wherein:
the hydrophilic-coating film has an average film thickness of 0.3-1.5 μm;
the hydrophilic-coating film is composed of a resin having an amide group, in which a hydrophilic polymer has been cross-linked by a cross-linking agent;
the hydrophilic polymer is composed of at least one selected from the group consisting of acrylic-modified epoxy resin, acrylic-cellulose resin, cellulose-melamine resin, cellulose-acetate resin, and polyoxyalkylene resin;
the cross-linking agent is composed of at least one selected from the group consisting of isocyanate, blocked polyisocyanate, and carbodiimide.

15. The precoated aluminum sheet according to claim 14, wherein 1 μm≤Rz_{LT}≤1.8 μm, and Rz_{L}/Rz_{LT}≤0.7.

16. The precoated aluminum sheet according to claim 15, wherein the contact angle is 15° or lower, and the sliding angle is 10° or lower.

17. The precoated aluminum sheet according to claim 16, wherein the hydrophilic polymer is composed of acrylic-modified epoxy resin.

18. A heat exchanger comprising:
a plurality of fins mounted on a metal tubing;
wherein each of the fins comprises an aluminum-based substrate and a hydrophilic-coating film formed on at least one surface of the substrate;
the hydrophilic-coating film has a surface roughness Rz_{L} in a rolling-parallel direction of the substrate and a surface roughness Rz_{LT} in a rolling-perpendicular direction of the substrate;
the following relationships are satisfied:
Rz_{L}≤1.5 μm,
0.3 μm≤Rz_{LT}≤2.5 μm, and
Rz_{L}/Rz_{LT}≤0.9; and
a contact angle of a water droplet with respect to the hydrophilic-coating film is 25° or lower, and a sliding angle of the water droplet in the rolling-parallel direction of the substrate is 20° or lower.

19. A method comprising:
rolling an aluminum substrate in a rolling direction;
forming a hydrophilic-coating film on the rolled aluminum substrate to prepare a precoated aluminum sheet such that:
the hydrophilic-coating film has a surface roughness Rz_{L} in the rolling direction of the substrate and a surface roughness Rz_{LT} in direction perpendicular to the rolling direction of the substrate, and
the following relationships are satisfied:
Rz_{L}≤1.5 μm,
0.3 μm≤Rz_{LT}≤2.5 μm, and
Rz_{L}/Rz_{LT}≤0.9; and
forming a plurality of fins from the precoated aluminum sheet;
wherein the hydrophilic-coating film is composed such that a contact angle of a water droplet with respect to the hydrophilic-coating film is 25° or lower, and a sliding angle of the water droplet in the rolling-parallel direction of the substrate is 20° or lower.

20. The method according to claim 19, further comprising:
after forming the plurality of fins from the precoated aluminum sheet, forming holes in each of the fins and forming collars around the holes;
inserting at least one metal tube into the holes of the fins;
inserting a tube-expanding plug into the at least one metal tube and enlarging an outer diameter of the at least one metal tube, thereby securing the at least one metal tube to the fins.
